(19) United States
(12) Patent Application Publication
(10) Pub. No.: US 2017/0243288 A1
(43) Pub. Date: Aug. 24, 2017

(54) DELIVERY APPARATUS, DELIVERY METHOD, NON-TRANSITORY COMPUTER READABLE STORAGE MEDIUM, AND DELIVERY SYSTEM

(71) Applicant: YAHOO JAPAN CORPORATION, Tokyo (JP)

(72) Inventors: Kyosuke ARAI, Tokyo (JP); Yosuke MORITA, Tokyo (JP); Yuki KOMATSU, Tokyo (JP); Saori KITAMURA, Tokyo (JP)

(73) Assignee: YAHOO JAPAN CORPORATION, Tokyo (JP)

(21) Appl. No.: 15/426,489

(22) Filed: Feb. 7, 2017

(30) Foreign Application Priority Data
Feb. 19, 2016 (JP) 2016-029904

(51) Int. Cl. G06Q 40/02; G06Q 30/06

(52) U.S. Cl. CPC G06Q 40/025; G06Q 30/0625

(57) ABSTRACT

A delivery apparatus according to the present application includes an acquisition unit, a generation unit, and a delivery unit. The acquisition unit acquires user information that represents information relating to a user. The generation unit generates, using the user information acquired by the acquisition unit, loan information that represents information including loan terms for the user. The delivery unit delivers the loan information generated by the generation unit to a terminal apparatus that is used by the user by using, as a trigger, display of predetermined service content at the terminal apparatus.

### CROSS-REFERENCE TO RELATED APPLICATION(S)

The present application claims priority to and incorporates by reference the entire contents of Japanese Patent Application No. 2016-029904 filed in Japan on Feb. 19, 2016.

### BACKGROUND OF THE INVENTION

1. Field of the Invention

The present invention relates to a delivery apparatus, a delivery method, a non-transitory computer readable storage medium having stored therein a delivery program, and a delivery system.

2. Description of the Related Art

Various services have lately been provided over a network in step with the advances in communication networks. One exemplary type of services provided over a network is a financial service such as a personal loan.

As a technique relating to financial services provided over a network, a known technique relates to a loan intermediary system that allows a loan to be obtained from a financial institution that offers the most advantageous loan terms, as selected from among a plurality of financial institutions. Conventional techniques are described in Japanese Patent Application Laid-open No. 2002-73983, for example.

The known technique does not, however, necessarily promote loans over the network. Specifically, the known technique simply extracts an appropriate financial institution and loan terms on the basis of loan application information transmitted from the user. More specifically, the known technique simply provides information for a user who is motivated to transmit the loan application information and finds difficulty in providing information for a user who tends to avoid the trouble of transmitting the loan application information.

### SUMMARY OF THE INVENTION

It is an object of the present invention to at least partially solve the problems in the conventional technology.

A delivery apparatus according to the present application includes an acquisition unit that acquires user information that represents information relating to a user, a generation unit that generates, using the user information acquired by the acquisition unit, loan information that represents information including loan terms for the user, and a delivery unit that delivers the loan information generated by the generation unit to a terminal apparatus that is used by the user by using, as a trigger, display of predetermined service content at the terminal apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary delivery process according to an embodiment;

FIG. 2 is a diagram illustrating an exemplary configuration of a delivery system according to the embodiment;

FIG. 3 is a diagram illustrating an exemplary configuration of a loan server according to the embodiment;

FIG. 4 is a diagram illustrating an exemplary user information table according to the embodiment;

FIG. 5 is a diagram illustrating an exemplary purchase history table according to the embodiment;

FIG. 6 is a diagram illustrating an exemplary SNS information table according to the embodiment;

FIG. 7 is a diagram illustrating an exemplary credit rating table according to the embodiment;

FIG. 8 is a diagram illustrating an exemplary loan terms table according to the embodiment;

FIG. 9 is a diagram illustrating an exemplary configuration of a content delivery server according to the embodiment;

FIG. 10 is a flowchart illustrating processing steps performed by the loan server according to the embodiment;

FIG. 11 is a diagram (1) illustrating an exemplary delivery process according to a modification;

FIG. 12 is a diagram (2) illustrating an exemplary delivery process according to a modification;

FIG. 13 is a diagram (3) illustrating an exemplary delivery process according to a modification; and

FIG. 14 is a hardware configuration diagram illustrating an exemplary computer that achieves functions of the loan server.

### DETAILED DESCRIPTION OF THE PREFERRED EMBODIMENTS

The following details, with reference to the accompanying drawings, modes (hereinafter referred to as “embodiments”) for carrying out a delivery apparatus, a delivery method, a non-transitory computer readable storage medium having stored therein a delivery program, and a delivery system according to the present application. It is to be understood that the embodiments do not intend to limit the delivery apparatus, the delivery method, the non-transitory computer readable storage medium having stored therein the delivery program, and the delivery system according to the present application. In each of the following embodiments, like or similar elements are identified by like reference numerals and descriptions for those elements will not be duplicated.

1. Exemplary Delivery Process

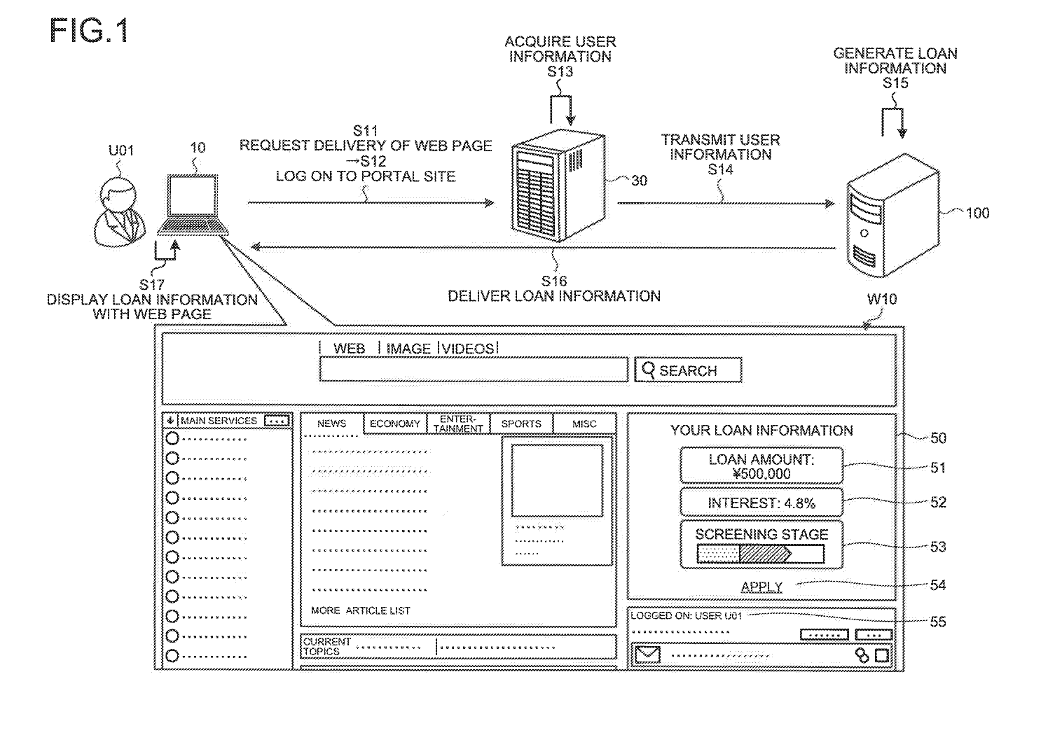

The following describes, with reference to FIG. 1, an exemplary delivery process according to an embodiment. FIG. 1 is a diagram illustrating the exemplary delivery process according to the present embodiment. FIG. 1 illustrates an exemplary process in which a loan server 100 that corresponds to the delivery apparatus according to the present application delivers loan information 50 to a user terminal 10 that represents a terminal apparatus used by a user. FIG. 1 also illustrates an exemplary process in which the user terminal 10 displays the loan information 50 that is delivered from the loan server 100.

The user terminal 10 illustrated in FIG. 1 is an information processing terminal that displays content such as a Web page. The user terminal 10 is, for example, a notebook personal computer (PC). The user terminal 10 is connected with a content delivery server 30 and the loan server 100 illustrated in FIG. 1 via a predetermined communication network not illustrated so as to be capable of communicating in a wired or wireless manner.

The user terminal 10 acquires a Web page from the content delivery server 30 and displays the acquired Web page in accordance with an operation performed by the user. The user terminal 10 displays, as information displayed in the acquired Web page, the loan information 50 delivered from the loan server 100. It should be noted that, in the following, the user terminal 10 may be denoted as the user. Specifically, in the following, the user may be replaced with the user terminal 10. In the example illustrated in FIG. 1, the user terminal 10 is used by a user U01.

The content delivery server 30 illustrated in FIG. 1 is a server apparatus that delivers content when accessed by the user terminal 10. The content delivery server 30 is, for example, a Web server that delivers a Web page relating to various services when accessed by the user terminal 10. In the example illustrated in FIG. 1, the content delivery server 30 delivers to the user terminal 10 a Web page W10 relating to a portal site in a Web network.

The loan server 100 illustrated in FIG. 1 is a server apparatus that corresponds to the delivery apparatus according to the present application. When the user terminal 10 accesses the content delivery server 30, the loan server 100 acquires user information that includes information on the user U01 who uses the user terminal 10 and information included in the user terminal 10. The loan server 100 generates loan information for each user on the basis of the user information. The loan server 100 then delivers the generated loan information to the user terminal 10. The following describes, with reference to FIG. 1, an exemplary process performed by the loan server 100 according to the present application to deliver the loan information 50 to the user terminal 10.

The user terminal 10 accesses the content delivery server 30 and requests delivery of the Web page W10 (Step S11). For example, the user U01 clicks a link to the Web page W10, displayed on the user terminal 10, to thereby request the content delivery server 30 to deliver the Web page W10.

As described previously, the Web page W10 relates to a portal site provided by the content delivery server 30. The Web page W10 is, for example, customized and displayed for each user. In this case, the user U01 logs on to the portal site in order for the Web page W10 to be customized to suit the user U01 (Step S12). For example, the user U01 logs on to the portal site by transmitting, together with the request for delivery of the Web page W10, a cookie issued from the portal site side.

The content delivery server 30 identifies the user terminal 10 using the delivery request and the cookie transmitted from the user terminal 10. The content delivery server 30 then acquires user information of the user terminal 10 thus identified (Step S13). The user information includes, for example, attribute information such as age and sex of the user U01 and a behavior history of network information of the user terminal 10.

The content delivery server 30 transmits the acquired user information to the loan server 100 (Step S14). The loan server 100 acquires the user information transmitted from the content delivery server 30. The loan server 100 generates loan information associated with the user U01 (Step S15).

The loan server 100 calculates a credit rating of the user U01 using the user information, which will be detailed later. On the basis of the credit rating of the user U01, the loan server 100 identifies loan terms that are enforceable with respect to the user U01. The loan server 100 then generates the loan information 50 that serves as information including the loan terms associated with the user U01. The loan server 100 delivers the generated loan information 50 to the user terminal 10 (Step S16).

The user terminal 10 displays the delivered loan information 50 together with the acquired Web page W10 (Step S17). As illustrated in FIG. 1, the user terminal 10 displays the loan information 50 within a predetermined display space included in the Web page W10. For example, the user terminal 10 displays the loan information 50, instead of advertisement content, in an advertisement space (advertisement display area) in which the advertisement content is normally displayed. It is noted that the Web page W10 may also display, for example, a logon display 55 that indicates that the user U01 has logged on.

The loan information 50 includes, for example, loan amount information 51 that represents information indicating an amount that can be financed to the user U01 and interest information 52 that represents information indicating an interest rate applicable to the loan to be granted to the user U01. The loan amount information 51 and the interest information 52 constitute part of the loan terms that are to be identified on the basis of the credit rating of the user U01.

The loan information 50 further includes screening stage information 53 that represents information indicating a stage at which the user U01 is assessed whether the loan can be granted and a link 54 that brings the user U01 to a loan application page. The screening stage information 53 indicates a stage of loan screening performed using the user information on the side of the loan server 100. The screening stage information 53 displays, for example, screening stages that are variable depending on various situations including where the credit rating of the user U01 is calculated and where the credit rating of the user U01 exceeds a predetermined threshold.

As described above, the loan server 100 in the embodiment acquires the user information that represents information on the user U01. The loan server 100 generates, on the basis of the acquired user information, the loan information that represents the information indicating the loan terms applicable to the user U01. The loan server 100 delivers the generated loan information to the user terminal 10 by using as a trigger an event that displays the Web page W10 on the user terminal 10 used by the user U01.

The foregoing arrangements enable the loan server 100 in the embodiment to present to the user U01 the loan information 50 calculated on the basis of the user information in the form of information that is displayed together with the Web page W10. The foregoing signifies that a mere visit by the user U01 to the portal site causes the loan information 50 associated with the user U01 to be delivered to the user terminal 10 and displayed together with the Web page W10. Specifically, the user U01 can automatically acquire the loan terms for which the user U01 can apply through daily behavior of visiting the Web page W10 that represents a service page the user U01 wants to browse without the need to input information about himself or herself. To state the foregoing differently, the loan server 100 can give the user U01 a chance to use a loan without causing the user U01 to take the trouble of visiting a page provided by a financial institution or inputting information about himself or herself. As a result, the loan server 100, because being able to present loan terms to those users who are not particularly interested in loans and those who are being hesitant to confirm whether a loan can be used, can promote loans over the network.

2. Configuration of Delivery System

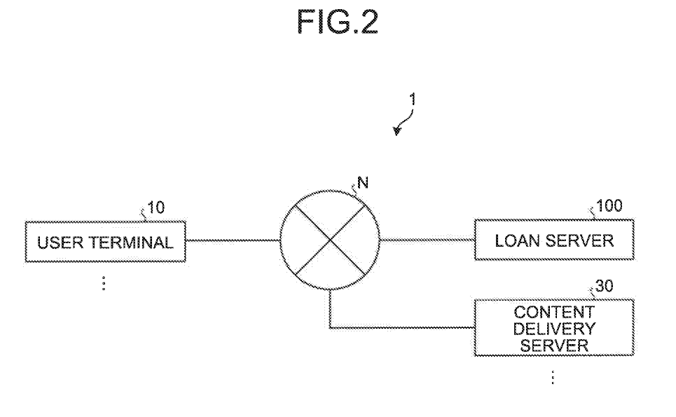

The following describes, with reference to FIG. 2, a configuration of a delivery system 1 in the embodiment. FIG. 2 is a diagram illustrating an exemplary configuration of the delivery system 1 according to the embodiment. As illustrated in FIG. 2, the delivery system 1 includes the user terminal 10, the content delivery server 30, and the loan server 100. The user terminal 10, the content delivery server 30, and the loan server 100 are connected with each other via a network N so as to be capable of communicating in a wired or wireless manner. Each of the elements included in the delivery system 1 illustrated in FIG. 2 is not limited in number to what is illustrated in FIG. 2. For example, the delivery system 1 may include a plurality of user terminals 10 and a plurality of content delivery servers 30.

The user terminal 10 is an information processing apparatus that is used by a user who browses content such as the Web page W10. For example, the user terminal 10 may be a desktop PC, a notebook PC, a portable telephone such as a smartphone, a table terminal, or a personal digital assistant (PDA). The user terminal 10 acquires the Web page W10 from the content delivery server 30 and displays the acquired Web page W10 in accordance with an operation performed by the user. Additionally, the user terminal 10 displays, together with the Web page W10, the loan information 50 delivered from the loan server 100.

The content delivery server 30 is a Web server that delivers a service page (Web page) including Web sites provided by various services to the user terminal 10. For example, the content delivery server 30 delivers to the user terminal 10 a Web page that includes various types of information related to portal sites, news sites, auction sites, weather forecasting sites, shopping sites, finance (stock prices) sites, route search sites, map providing sites, travel sites, restaurant introducing sites, and Web blogs.

It is noted that various types of data delivered from the content delivery server 30 to the user terminal 10 include, in reality, HTML files and images that constitute a Web page, for example. The various types of data delivered from the content delivery server 30 to the user terminal 10 may, however, be denoted as content in the following.

The loan server 100 is a server apparatus that corresponds to the delivery apparatus in the present application, delivering loan information to the user terminal 10. For example, the loan server 100 acquires user information relating to the user terminal 10 and, on the basis of the user information, calculates a credit rating of the user as the user relating to the user terminal 10. The loan server 100 generates loan information on the basis of the calculated credit rating. Additionally, when the user terminal 10 acquires a Web page from the content delivery server 30, the loan server 100 delivers the loan information to thereby display the loan information 50 together with the Web page.

3. Configuration of Loan Server

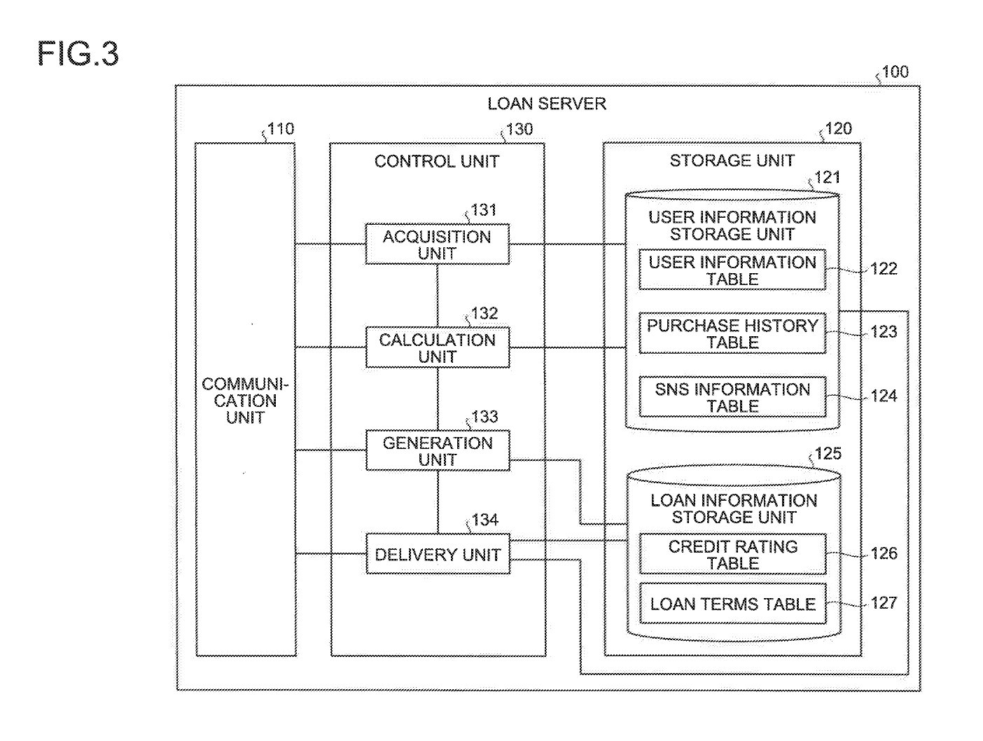

The following describes, with reference to FIG. 3, a configuration of the loan server 100 according to the embodiment. FIG. 3 is a diagram illustrating an exemplary configuration of the loan server 100 according to the embodiment. As illustrated in FIG. 3, the loan server 100 includes a communication unit 110, a storage unit 120, and a control unit 130. It is noted that the loan server 100 may include an input unit (e.g., a keyboard and a mouse) that receives various types of operations performed by, for example, an administrator who uses the loan server 100 and an output unit (e.g., a liquid crystal display) for outputting various types of information.

Communication Unit 110

The communication unit 110 is achieved by, for example, a network interface card (NIC). The communication unit 110 is connected with a communication network in a wired or wireless manner and transmits and receives information to and from the user terminal 10 and the content delivery server 30.

Storage Unit 120

The storage unit 120 may be achieved by, for example, a semiconductor memory device such as a random access memory (RAM) and a flash memory or a storage device such as a hard disk and an optical disc. The storage unit 120 in the embodiment includes a user information storage unit 121 and a loan information storage unit 125. The following describes each of the user information storage unit 121 and the loan information storage unit 125 in sequence.

User Information Storage Unit 121

The user information storage unit 121 stores therein user information that represents information relating to the user. The user information storage unit 121 includes, as data tables storing therein information, a user information table 122, a purchase history table 123, a social networking service (SNS) information table 124. The following describes each of the user information table 122, the purchase history table 123, and the SNS information table 124 in sequence.

User Information Table 122

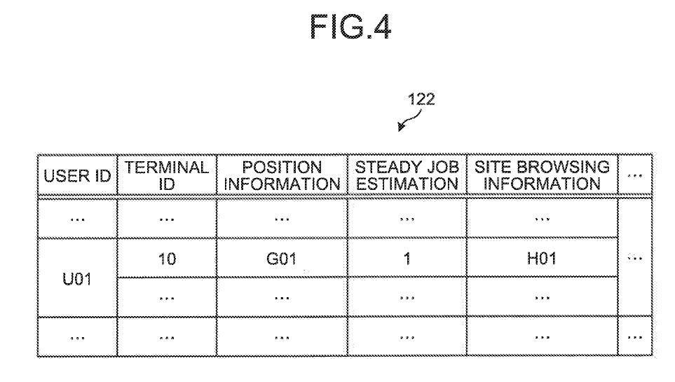

The user information table 122 stores therein information on the user who uses the loan information. Reference is now made to FIG. 4 that illustrates an example of the user information table 122 according to the embodiment. As illustrated in FIG. 4, the user information table 122 includes such items as “user ID”, “terminal ID”, “position information”, “steady job estimation”, and “site browsing information”.

The item “user ID” denotes identification information for identifying a specific user. The item “terminal ID” denotes identification information for identifying a specific terminal apparatus used by the user. It is noted that, in the embodiment, the user ID and the terminal ID are identified by respective reference numerals used in the descriptions. Specifically, a user identified by a user ID of “U01” is denoted as the “user U01”. A terminal apparatus identified by a terminal ID of “10” is denoted as the “user terminal 10”.

The item “position information” denotes position information acquired from the user terminal 10. In the example illustrated in FIG. 4, the position information is represented by a conceptual code of “G01”. In reality, however, the position information contains a log of position information of the user in his or her daily lives, acquired and accumulated by the user terminal 10.

For example, the position information is a set of data representing longitude and latitude which the user terminal 10 can acquire through the use of the global positioning system (GPS). Alternatively, the position information may be information that represents, based on a log of non-contact communications performed when the user terminal 10 moves past a ticket gate of transportation, time of day at which the user terminal 10 passes a station and a position of the station. The position information may be information recorded based on a log of non-contact communications performed when the user terminal 10 passes the company gate the user works for. Specifically, the position information does not necessarily have to accurately indicate longitude and latitude. Any type of information may be employed when the information allows daily movements of the user to be estimated.

The item “steady job estimation” denotes information estimated by the loan server 100 to determine whether the user has a steady job on the basis of the position information. When, for example, the loan server 100 estimates that the user has a steady job, “1” is stored in the “steady job estimation” item. When the loan server 100 estimates that the user does not have any steady job, “0” is stored in the “steady job estimation” item.

The loan server 100 performs a steady job estimation for the user, for example, on the basis of changes in the position information. When position information is available indicating that the user moves regularly from a location where he or she leads an everyday life to a predetermined location, or indicating that the user is estimated to spend a good part of every weekday at a specific location, the loan server 100 determines that the user is highly likely to have a steady job. In this case, the loan server 100 inputs a “1” to the “steady job estimation” item of the user. In contrast, when the position information does not suggest that the user commutes to work regularly, the loan server 100 determines that the user is highly likely to have no steady job. In this case, the loan server 100 inputs a “0” to the “steady job estimation” item of the user. The numeric value of the steady job estimation is used, for example, for calculating the credit rating to be described later.

The item “site browsing information” denotes information on a history of browsing Web sites and applications. For example, the user terminal 10 acquires, as a history (log), information on Web sites viewed by the user and applications used by the user. The loan server 100 acquires a log of the user terminal 10 used for browsing, for example, Web sites and stores therein the log as site browsing information. In the example illustrated in FIG. 4, the site browsing information is represented by a conceptual code of “H01”. In reality, however, the “site browsing information” item contains a log of browsing information of the user in his or her daily lives, acquired and accumulated by the user terminal 10. The browsing information log includes, for example, a name, category, browsing time, browsing frequency of a Web site browsed by the user, and a cookie of each Web site.

Specifically, FIG. 4 illustrates as an example of user information that a user U01 identified by the user ID “U01” uses a user terminal 10 identified by the terminal ID “10”. Additionally, the exemplary information illustrated in FIG. 4 illustrates that the position information of the user U01 is “G01”, the steady job estimation of the user U01 is a “1”, and the site browsing information of the user U01 is “H01”.

The user information table 122 may store therein as miscellaneous information attribute information (e.g., sex, age, and place of residence) of the user.

Purchase History Table 123

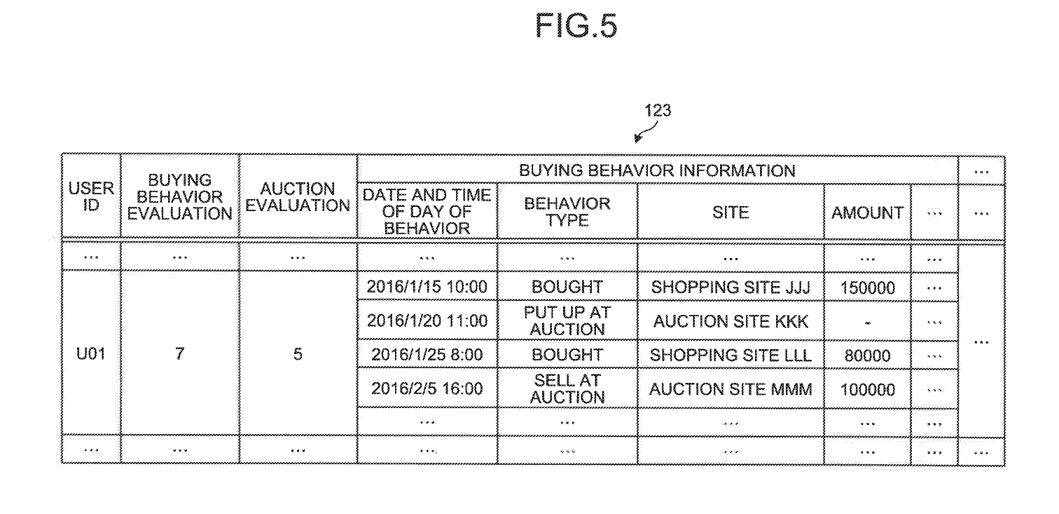

The purchase history table 123 stores therein information relating to a history of buying behavior of a user, acquired over the network. Reference is now made to FIG. 5 that illustrates an example of the purchase history table 123 according to the embodiment. As illustrated in FIG. 5, the purchase history table 123 includes such items as “user ID”, “buying behavior evaluation”, “auction evaluation”, and “buying behavior information”.

The item “user ID” corresponds to the identical item illustrated in FIG. 4. The item “buying behavior evaluation” indicates an evaluation value relating to buying behaviors of the user on the network. In the embodiment, the buying behavior evaluation is represented by a numeric value that is variable in 10 steps. A numeric value of 10 is the highest rating and a numeric value of 1 is the lowest rating. Specifically, the buying behavior evaluation is an index value for evaluating the user in terms of his or her buying behavior. The buying behavior evaluation is calculated on the basis of, for example, a total amount of money spent by the user on buying commodities for a predetermined period of time (e.g., one month), frequency of buying behavior, and whether the buying behavior has been appropriate (whether there was a payment delay). The buying behavior evaluation may instead be a numeric value (e.g., an average value) that is obtained from an evaluation value that represents a total value of evaluation made of the user by each shop.

The item “auction evaluation” indicates an evaluation value of user behaviors in a predetermined auction site when the user uses the auction site. In the embodiment, the auction evaluation is represented by a numeric value that is variable in 10 steps. A numeric value of 10 is the highest rating and a numeric value of 1 is the lowest rating. The auction evaluation indicates the credit rating of the user in terms of auction. For example, the auction evaluation is calculated on the basis of, for example, whether the transaction has been performed appropriately through prompt exchange of communications and with no delay in payment, frequency at which the user places an article for auction, and frequency at which the user buys an article at an auction. The auction evaluation may instead be a numeric value (e.g., an average value) that is obtained from an evaluation value that represents a total value of evaluations made of the user being evaluated by other users who participate in the auction.

The item “buying behavior information” denotes a behavior history (behavior log) relating to buying behaviors of the user. The buying behavior information includes such subitems as “date and time of day of behavior”, “behavior type”, “site”, and “amount”.

The subitem “date and time of day of behavior” indicates the date and time of day when the user performed, for example, the buying behavior. The subitem “behavior type” indicates the type of buying behavior of the user. For example, behaviors such as purchasing commodities, and putting up, buying, or selling commodities at auction are stored in the “behavior type” subitem. The subitem “site” indicates the name of a Web site at which the user performed the buying behavior. The subitem “amount” indicates the amount of money involved in the buying behavior.

Specifically, FIG. 5 illustrates that information relating to the purchase history of the user U01 identified by the user ID of “U01” is stored as exemplary information relating to the behavior history. The example of information illustrated in FIG. 5 further illustrates that the buying behavior evaluation of the user U01 is “7” and the auction evaluation of the user U01 is “5”. Additionally, the example of information illustrated in FIG. 5 illustrates that, as one piece of buying behavior information for the user U01, the user U01 has a history that the user U01 “bought a commodity” at “shopping site JJJ” for an amount of “¥150,000”.

It is noted that the purchase history table 123 may store therein additional information relating to the buying behavior of the user, in addition to the exemplary items illustrated in FIG. 5. For example, the purchase history table 123 may store therein, for example, a history of downloading free content involving no monetary transaction.

SNS Information Table 124

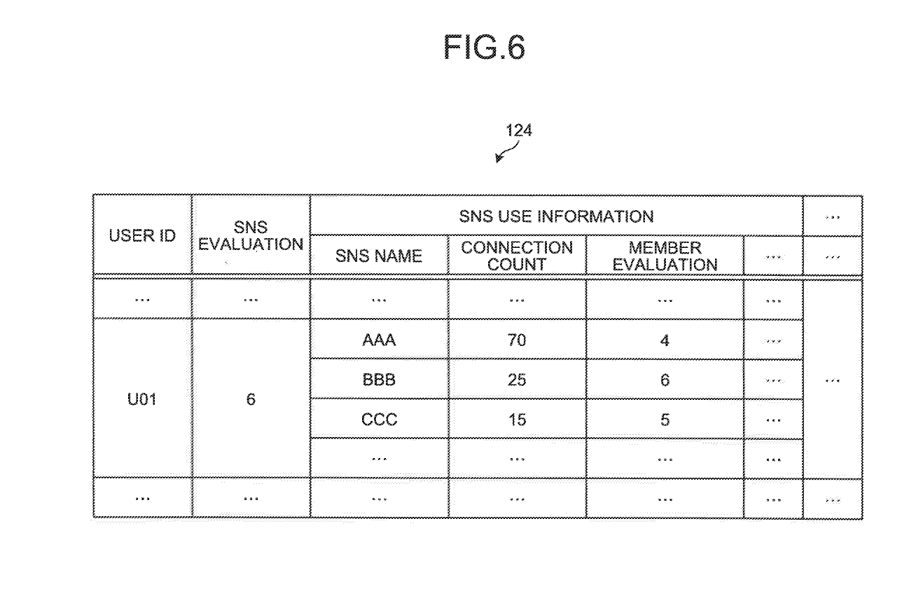

The SNS information table 124 stores therein information relating to an SNS used by the user. Reference is now made to FIG. 6 that illustrates an example of the SNS information table 124 according to the embodiment. As illustrated in FIG. 6, the SNS information table 124 includes such items as “user ID”, “SNS evaluation”, and “SNS use information”.

The item “user ID” corresponds to the identical item illustrated in FIG. 4. The item “SNS evaluation” represents an evaluation value relating to SNSs used by the user. In the embodiment, the item “SNS evaluation” is represented by a numeric value that is variable in 10 steps. A numeric value of 10 is the highest rating and a numeric value of 1 is the lowest rating. The SNS evaluation represents a value of evaluating, for example, social creditworthiness of the user on the basis of a history of use of the SNS. The SNS evaluation is calculated on the basis of, for example, the number of connections (denoted as “connection count” in the embodiment) established with other users in the SNS used by the user and values of evaluation made by other users connected with the user.

The item “SNS use information” indicates information relating to conditions of use of the SNS used by the user. The SNS use information includes such subitems as “SNS name”, “connection count”, and “member evaluation”.

The item “SNS name” indicates the name of the SNS used by the user. The item “connection count” represents the number of connections with other users in the SNS. For example, the connection count corresponds to the number of following users in the SNS. The item “member evaluation” represents evaluations of the other users connected with the user in the SNS. As with the SNS evaluation, the member evaluation is, for example, represented by a numeric value that is variable in 10 steps and calculated by averaging evaluation values of the other users connected with the user. Greater values of the member evaluation result in higher SNS evaluations of other users connected with the user. To state the foregoing differently, greater values of member evaluation indicate that the user has many connections with other users who have high social creditworthiness.

Specifically, FIG. 6 illustrates that, as exemplary SNS use information of the user, information relating to SNS use of the user U01 who is identified by a user ID of “U01” is stored and the SNS evaluation of the user U01 is “6”. Additionally, the exemplary information illustrated in FIG. 6 illustrates that an exemplary SNS used by the user U01 has an SNS name of “AAA” and, at the SNS site “AAA”, the connection count with other users is “70” and the member evaluation is “4”.

It is noted that the SNS information table 124 may store therein, for example, information on social statuses and income levels of the other users connected with the user. The loan server 100 may then calculate the value of member evaluation on the basis of the information on the social statuses and income levels of the other users connected with the user. In calculating the SNS evaluation of the user, the loan server 100 can thereby use the member evaluation to which the information on the social statuses and income levels of the other users connected with the user is added. The loan server 100 can thus accurately calculate the social creditworthiness of the user in question.

Loan Information Storage Unit 125

The loan information storage unit 125 stores therein information relating to loans. The loan information storage unit 125 includes, as data tables storing therein information, a credit rating table 126 and a loan terms table 127. The following describes the credit rating table 126 and the loan terms table 127 in sequence.

Credit Rating Table 126

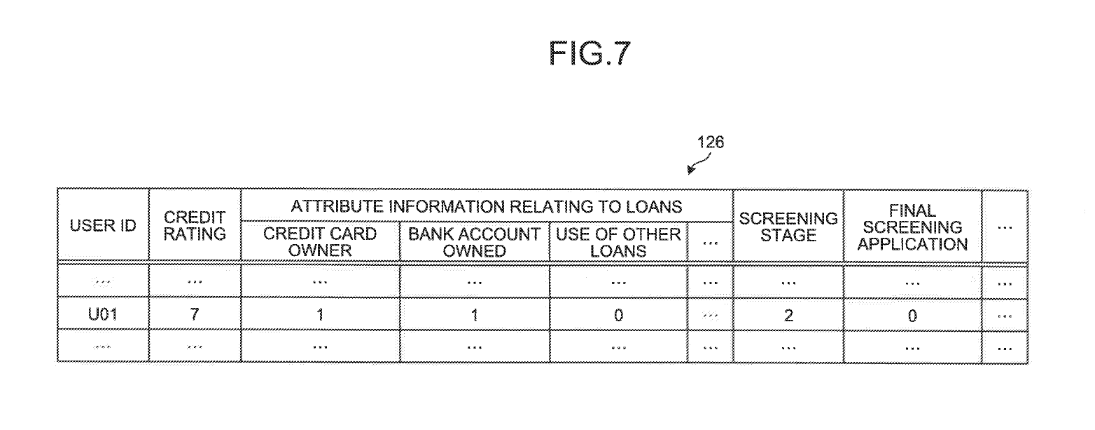

The credit rating table 126 stores therein information on the credit rating of the user and information related to loans. Reference is now made to FIG. 7 that illustrates an example of the credit rating table 126 according to the embodiment. As illustrated in FIG. 7, the credit rating table 126 includes such items as “user ID”, “credit rating”, “attribute information relating to loans”, “screening stage”, and “final screening application”.

The item “user ID” corresponds to the identical item illustrated in FIG. 4. The “credit rating” denotes the credit rating of the user to be referred to by the loan server 100 when the loan server 100 generates the loan information 50. In the embodiment, the credit rating is represented by a numeric value that is variable in 10 steps. A numeric value of 10 is the highest credit rating and a numeric value of 1 is the lowest credit rating. The loan server 100 calculates the credit rating of the user using the information stored in each of the abovementioned data tables. The loan server 100 then stores the calculated numerical value in the credit rating table 126 by associating the numerical value with the user ID.

The item “attribute information relating to loans” represents attribute information of the user, denoting information relating to loans. The attribute information relating to loans includes such subitems as “credit card owned”, “bank account owned”, and “use of other loans”.

The subitem “credit card owned” indicates whether the user owns a credit card. If the user owns a credit card, “1” is stored in the credit card owned subitem. If the user does not own a credit card, “0” is stored in the credit card owned subitem. The information on whether the user owns a credit card is determined using, for example, a history of use of a shopping site or an auction site by the user. It is noted that the credit card owned subitem may contain not only the information on whether the user owns a credit card, but also the brand name of the card owned by the user and the number of credit cards owned by the user, for example.

The subitem “bank account owned” indicates whether the user owns a bank account. If the user owns a bank account, “1” is stored in the bank account owner subitem. If the user does not own a bank account, “0” is stored in the bank account owner subitem. The information on whether the user owns a bank account is determined using, for example, a history of use of a shopping site or an auction site by the user. It is noted that the bank account owner subitem may contain not only the information on whether the user owns a bank account, but also the name of the bank corresponding to the bank account owned by the user and the number of bank accounts owned by the user, for example.

The subitem “use of other loans” represents information on whether any loan other than the loan information generated by the loan server 100 has been granted (specifically, whether any other loan has been obtained). If the user has obtained another loan, “1” is stored in the use of other loans subitem. If the user has not obtained any other loan, “0” is stored in the use of other loans subitem. It is noted that the use of other loans subitem may contain not only the information on whether the user uses any other loan, but also the name of the loan used by the user and the amount of loan used by the user, for example.

The item “screening stage” indicates the stage of screening relating to the loan generated by the loan server 100. For example, the screening stage is represented by a numeric value that is variable in four steps. A numeric value of 3 indicates that the screening is in the most advanced stage and a numeric value of 0 indicates that the screening is yet to progress. Consider, for example, a user who is rated “1” in terms of the screening stage. Such a user is in a position in which he or she has been rated for credit rating by the loan server 100 and has undergone simplified screening to be entitled to the loan. Consider another user who is rated “2” in terms of the screening stage. Such a user is in a position in which he or she has been confirmed in terms of owned credit cards and bank accounts, by the loan server 100 and has thus undergone preliminary screening for the loan. Consider still another user who is rated “3” in terms of the screening stage. Such a user clicked the “application” link when the loan information 50 was once displayed and has passed the final screening relating to the loan to the user.

The item “final screening application” represents information on whether the user has already applied for a loan in response to the loan information 50 delivered by the loan server 100. For example, if the user has applied for the loan, “1” is stored in the final screening application item. If the user is yet to apply for the loan, “0” is stored in the final screening application item.

Specifically, FIG. 7 illustrates, as exemplary information relating to the credit rating and loan of the user, information relating to the credit rating and loan of the user U01 who is identified by a user ID of “U01”. Additionally, the exemplary information illustrated in FIG. 7 indicates that, with respect to the user U01, the credit rating is “7”, the user U01 owns a credit card and a bank account, and the user U01 does not use any other loans. Furthermore, the exemplary information illustrated in FIG. 7 indicates that the user U01 is in a screening stage of “2” and is yet to apply for the final screening.

Loan Terms Table 127

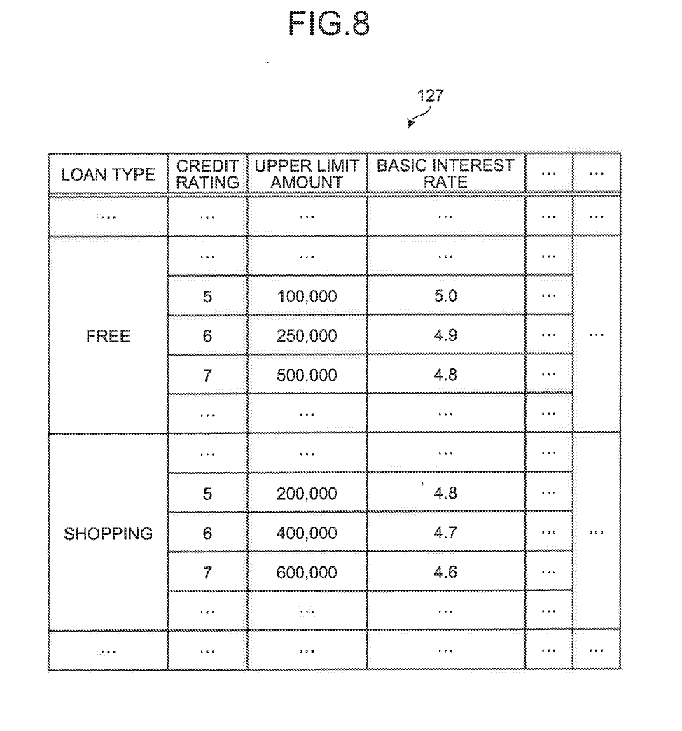

The loan terms table 127 stores therein information relating to loan terms. Reference is now made to FIG. 8 that illustrates an example of the loan terms table 127 according to the embodiment. As illustrated in FIG. 8, the loan terms table 127 includes such items as “loan type”, “credit rating”, “upper limit amount”, and “basic interest rate”.

The item “loan type” denotes the type of loan corresponding to the loan information 50 generated by the loan server 100. The loan type is, for example, the type of a loan classified according to the purpose for which the money to be loaned is to be used. For example, for the loan classified into a loan type of “free”, the user who obtains the loan is free of restrictions imposed on the use of the loan. For the loan classified into a loan type of “shopping”, restrictions are imposed on the use of the loan and the user who obtains such a loan is required to use the loan for shopping. Other types of loans include loans for housing, and renovation and remodeling (housing loans), loans for automobiles (auto loans), loans for learning (study loans), and loans for ceremonial occasions.

The item “credit rating” corresponds to the identical item illustrated in FIG. 7. The item “upper limit amount” specifies an upper limit of the loan amount. As illustrated in FIG. 8, the upper limit amount is established according to the credit rating of the user. The item “basic interest rate” indicates a basic interest rate of the loan. As illustrated in FIG. 8, the basic interest rate is established according to the credit rating of the user. It is noted that, when the loan is to be actually granted to the user, the upper limit amount and the basic interest rate may be adjusted as appropriate on the basis of various types of user information in addition to the credit rating.

Specifically, FIG. 8 illustrates, as exemplary information relating to the loan terms, an example in which the loan type is “free” in the loan information generated by the loan server 100. Additionally, the exemplary information illustrated in FIG. 8 indicates that the loan terms having an upper limit amount of “100,000” yen and a basic interest rate of “5.0”% are presented to a user having a credit rating of “5”.

Control Unit 130

The control unit 130 is achieved by, for example, a central processing unit (CPU) or a micro-processing unit (MPU) executing various types of programs (that may correspond to, for example, an exemplary execution program) stored in a storage device inside the loan server 100 using the RAM as a work space. Additionally, the control unit 130 may be achieved by an integrated circuit, such as an application specific integrated circuit (ASIC) and a field programmable gate array (FPGA).

As illustrated in FIG. 3, the control unit 130 according to the embodiment includes an acquisition unit 131, a calculation unit 132, a generation unit 133, and a delivery unit 134. The control unit 130 thereby achieves or performs information processing functions and operations to be described below. It is noted that the control unit 130 may have an internal configuration that is not limited to the configuration illustrated in FIG. 3, but is required only to perform the information processing to be described later. The connection among different processing units included in the control unit 130 is not limited to what is illustrated in FIG. 3, but may be any other one.

Acquisition Unit 131

The acquisition unit 131 acquires various types of information. For example, the acquisition unit 131 acquires user information that represents information relating to the user. Specifically, the acquisition unit 131 acquires the user information such as identification information that identifies the user and the user terminal 10, attribute information of the user, position information of the user, and a behavior history of the user on the network.

As the behavior history of the user on the network, the acquisition unit 131 acquires, for example, a history relating to buying behavior of the user on the network. Specifically, the acquisition unit 131 acquires the buying behavior on the network such as a purchase amount in the buying behavior or frequency of the buying behavior. In this case, the acquisition unit 131 may acquire the information relating to the buying behavior of the user from, for example, a service provider server including a Web server that operates a shopping site or an auction site.

Additionally, the acquisition unit 131 may acquire information relating to at least any of name recognition, reputation, and personal connections of the user within a service for building a social network used by the user. The service for building a social network refers to, for example, an SNS service. Additionally, the name recognition, reputation, and personal connections of the user are determined on the basis of, for example, the SNS evaluation, the number of connections requested by other users, the number of connections with other users, and the SNS evaluation of other users.

The acquisition unit 131 stores the acquired information in the user information storage unit 121. It is noted that a configuration may be arranged so as to allow the acquisition unit 131 to acquire the user information from any apparatus. Specifically, the acquisition unit 131 may acquire the user information, as appropriate, from not only the user terminal 10 or the content delivery server 30, but also a predetermined external server.

The acquisition unit 131 may acquire via the content delivery server 30 information relating to a service page (Web page) accessed by the user terminal 10. For example, the acquisition unit 131 may acquire information on the Web page that displays the loan information 50, including whether the Web page to be displayed by the user terminal 10 pertains to a portal site page, a search site page, or a page relating to shopping or ceremonial occasions.

Calculation Unit 132

The calculation unit 132 calculates the credit rating of the user on the basis of the user information acquired by the acquisition unit 131. For example, the calculation unit 132 calculates the credit rating of the user on the basis of the behavior history of the user on the network. The credit rating of the user is used, for example, by the loan server 100 to generate the loan information 50.

The calculation unit 132 calculates the credit rating of the user on the basis of, for example, a plurality of pieces of position information that indicate respective points within a predetermined range and that are acquired on a daily basis out of the position information acquired by the acquisition unit 131. Specifically, the calculation unit 132 refers to the position information acquired as the user information and extracts a log that indicates movements of the user to a substantially identical place on a daily basis. The calculation unit 132 then uses, for example, a known estimation technique to thereby estimate the place to which the user moves on a daily basis as his or her workplace. The calculation unit 132 thereby estimates that the user is highly likely to have a steady job. The calculation unit 132 calculates the credit rating of the user who has an attribute of having a steady job as being higher by a predetermined value than a credit rating of a user who has an attribute of having no steady job.

The calculation unit 132 calculates, in terms of the buying behavior of the user, values of the buying behavior evaluation and the auction evaluation as illustrated in FIG. 5. The calculation unit 132 further calculates the credit rating of the user on the basis of the values of the buying behavior evaluation and the auction evaluation. For example, the calculation unit 132 gives high credit ratings for users having high purchase records, high purchase amounts, and acting adequately to purchasing. To state the foregoing differently, the calculation unit 132 gives high credit ratings for users having high financial power and high social creditworthiness. The calculation technique used by the calculation unit 132 for evaluating, for example, the buying behavior (e.g., behavior frequency and purchase amount) may be changed as appropriate by, for example, the administrator of the loan server 100.

The calculation unit 132 calculates, in terms of use of the SNS by the user, values of the SNS evaluation as illustrated in FIG. 6. The calculation unit 132 calculates the credit rating of the user on the basis of the values of the SNS evaluation. Specifically, the calculation unit 132 highly evaluates those users who have high connection counts and a large number of connections with highly evaluated other users and calculates the credit ratings in terms of these aspects. To state the foregoing differently, the calculation unit 132 gives high credit ratings for users who are estimated to have high social creditworthiness and high social positions.

The calculation unit 132 totals individual values of the buying behavior evaluation, the auction evaluation, and the like to arrive at a comprehensive credit rating of the user in question. Specifically, the calculation unit 132 calculates a comprehensive credit rating of the user on the basis of various types of user information acquired by the acquisition unit 131. This approach enables the calculation unit 132 to give the user a credit rating in which the financial power and social creditworthiness of the user are accurately incorporated.

Generation Unit 133

The generation unit 133 generates the loan information 50 that assumes information including the loan terms for the user on the basis of the user information acquired by the acquisition unit 131. Specifically, the generation unit 133 generates the loan information 50 for the user on the basis of the credit rating of the user calculated by the calculation unit 132.

For example, the generation unit 133 generates the loan information 50 that includes as the loan terms the type of the loan, the upper limit amount of the loan, and the interest rate applicable to the loan for the user. The generation unit 133 identifies a user terminal 10 that has requested the content delivery server 30 to acquire a Web page and, on the basis of the user information corresponding to the user terminal 10, generates the loan information 50. In this case, the generation unit 133 calculates the credit rating of a user who uses the user terminal 10. The generation unit 133 refers to the loan terms table 127 for the upper limit amount and the interest rate applicable to the loan corresponding to the credit rating of the user. The generation unit 133 then generates the loan information 50 using the upper limit amount and the interest rate corresponding to the credit rating of the user as the loan terms for the user in question.

The generation unit 133 may generate loan information 50 that corresponds to the loan type related to information on a predetermined service page acquired by the acquisition unit 131. When the user acquires a page relating to a portal site, for example, the generation unit 133 generates the loan information 50 having “free loan” for the loan type. When the user acquires a page relating to a shopping site, the generation unit 133 generates the loan information 50 having “shopping loan” for the loan type. Alternatively, when the user acquires a page relating to an automobile site, the generation unit 133 generates the loan information 50 having “auto loan” for the loan type. Still alternatively, when the user acquires information that represents a Web page relating to ceremonial occasions or housing, the generation unit 133 may generate loan information 50 relating to a type of loan corresponding to the foregoing page.

The generation unit 133 may generate loan information 50 that includes the screening stage for the loan. Specifically, the generation unit 133 generates, on the basis of the user information, loan information 50 that includes the screening stage that can indicate information on a level of likelihood that the loan will be granted at the present moment without receiving an application for a loan from the user. For example, the generation unit 133 generates the loan information 50 that may be displayed in a form of a bar graph indicating the screening stage as with the screening stage information 53 illustrated in FIG. 1.

As described with reference to FIG. 7, the screening stage is set as appropriate on the basis of information acquired from the user. It is noted that the screening stage is not limited to being displayed in a form of three steps as illustrated in FIG. 1. For example, the screening stage may be displayed in a form in which progress is indicated by percentage.

Delivery Unit 134

The delivery unit 134 delivers the generated loan information 50 generated by the generation unit 133 to the user terminal 10 by using as a trigger an event that displays a predetermined service page (e.g., Web page) at the user terminal 10 used by the user. The delivery unit 134 further delivers to the user terminal 10 the loan information 50 as display information together with the predetermined service page.

For example, the delivery unit 134 delivers, as information displayed together with the Web page, the loan information that is generated by the generation unit 133 and that corresponds to the type related to the Web page to the user terminal 10. Specifically, the delivery unit 134 delivers the loan information 50 corresponding to a shopping loan to the user terminal 10 that displays a shopping page.

The delivery unit 134 may determine whether to deliver the loan information 50 on the basis of the Web page acquired by the user. For example, the acquisition unit 131 acquires, as information relating to the Web page, information on whether the Web page to be acquired by the user terminal 10 represents a service having a high loan usage rate at which a certain user uses a loan. Such information is set by, for example, the administrator of the content delivery server 30 or a Web page provider.

The administrator of the content delivery server 30, for example, classifies Web pages into categories and assigns information on whether the category to which a Web page belongs has a high loan usage rate at which a certain user uses a loan. Specifically, when a Web page relates to sales of automobiles, wedding halls, or sales of housing, information that the Web page relates to a service having a high loan usage rate at which a certain user uses a loan is assigned to the Web page. Alternatively, the information that the service has a high loan usage rate may be automatically set on the basis of, for example, a history of browsing, by a user to which the loan server 100 has actually granted a loan.

When the acquisition unit 131 determines that the Web page to be acquired by the user terminal 10 is a service having a high loan usage rate, the delivery unit 134 delivers the loan information 50. For example, the delivery unit 134 may deliver to the user terminal 10 the loan information 50 as information that is to be displayed together with any of the following pages: a portal site page on which information is built for each visiting user, a search result page indicative of use of a search service, and an E-commerce page on which a commodity can be purchased. This approach allows the delivery unit 134 to generate an impression of the loan information 50 by narrowing down the users to those who are expected to be interested in commodities that may involve use of loans. The loan information 50 can thus achieve a greater appealing effect.

The delivery unit 134 may deliver the loan information 50 to the user terminal 10 that is used by a user who has ever applied for a predetermined loan and failed in screening of the application. Specifically, if information that a user has applied for a loan and yet failed in the screening is acquired as user information, the delivery unit 134 delivers the loan information 50 to that user who has the behavior history. The delivery unit 134 delivers the loan information 50 to a specific user who intends to obtain a loan in the foregoing manner, to thereby be able to promote applications for the loan by way of the loan information 50.

The delivery unit 134 may deliver the loan information 50 to the user terminal 10 that is used by a user qualified for receiving the loan indicated in the loan information 50 at a time when the loan information 50 is generated. For example, the delivery unit 134 delivers the loan information 50 to the user terminal 10 that is used by a user for whom the credit rating has been calculated at least on the basis of the user information and who has been determined to be entitled to the loan. As a result, the delivery unit 134 can avoid generating wasteful impressions of the loan information 50.

The delivery unit 134 may even deliver the loan information 50 to the user terminal 10 that is used by a user who has a certain loan amount left to which the user is entitled, against the loan amount indicated in the loan information 50 when the loan information 50 is generated by the generation unit 133. For example, the delivery unit 134 delivers the loan information 50 to only a user who is yet to receive a full amount of the upper limit amount against the loan indicated in the loan information 50. A user who has received the loan up to the upper limit amount can no longer receive the loan indicated in the loan information 50. The delivery unit 134 thus can avoid wastefully delivering the loan information 50. When a user uses another loan and has already received the loan up to the upper limit amount of the other load indicated in the loan information 50, the delivery unit 134 may opt not to deliver the loan information 50 to that user. When having determined not to deliver the loan information 50 to a user, the delivery unit 134 may deliver content that may be replaced by the loan information 50. For example, the delivery unit 134 delivers advertisement content in place of the loan information 50. Specifically, the delivery unit 134 transmits control information to an external advertisement delivery server to thereby cause the external advertisement delivery server to deliver the advertisement content to the user.

4. Configuration of Content Delivery Server

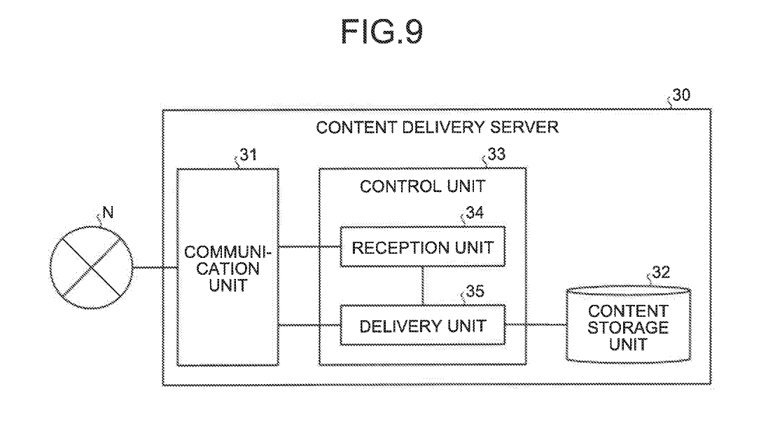

The following describes, with reference to FIG. 9, a configuration of the content delivery server 30 according to the embodiment. FIG. 9 is a diagram illustrating an exemplary configuration of the content delivery server 30 according to the embodiment. As illustrated in FIG. 9, the content delivery server 30 includes a communication unit 31, a content storage unit 32, and a control unit 33.

The communication unit 31 is achieved by, for example, a NIC. The communication unit 31 is connected with the network N in a wired or wireless manner and transmits and receives information to and from the user terminal 10 and the loan server 100.

The content storage unit 32 is achieved by, for example, a semiconductor memory device such as a RAM and a flash memory or a storage device such as a hard disk and an optical disc. The content storage unit 32 stores therein Web pages as exemplary content. For example, the content storage unit 32 stores therein an HTML file that forms a Web page and a still image and a moving image displayed on the Web page.

The control unit 33 is achieved by, for example, a CPU or a MPU executing various types of programs stored in a storage device inside the content delivery server 30 using the RAM as a work space. Additionally, the control unit 33 may be achieved by an integrated circuit, such as an ASIC and an FPGA.

As illustrated in FIG. 9, the control unit 33 includes a reception unit 34 and a delivery unit 35. The control unit 33 thereby achieves or performs information processing functions and operations to be described below. It is noted that the control unit 33 may have an internal configuration that is not limited to the configuration illustrated in FIG. 9, but is required only to perform the information processing to be described later. The connection among different processing units included in the control unit 33 is not limited to what is illustrated in FIG. 9, but may be any other.

The reception unit 34 receives a request to acquire a Web page from the user terminal 10. For example, the reception unit 34 receives an HTTP request as the request to acquire a Web page.

When the reception unit 34 receives a request to acquire a Web page, the delivery unit 35 delivers the Web page to the user terminal 10. Specifically, the delivery unit 35 acquires from the content storage unit 32 the Web page for which the acquisition request has been made and delivers the acquired Web page to the user terminal 10. Additionally, the delivery unit 35 transmits to the loan server 100 user information that corresponds to the user terminal 10 that has requested to acquire the Web page.

5. Processing Steps

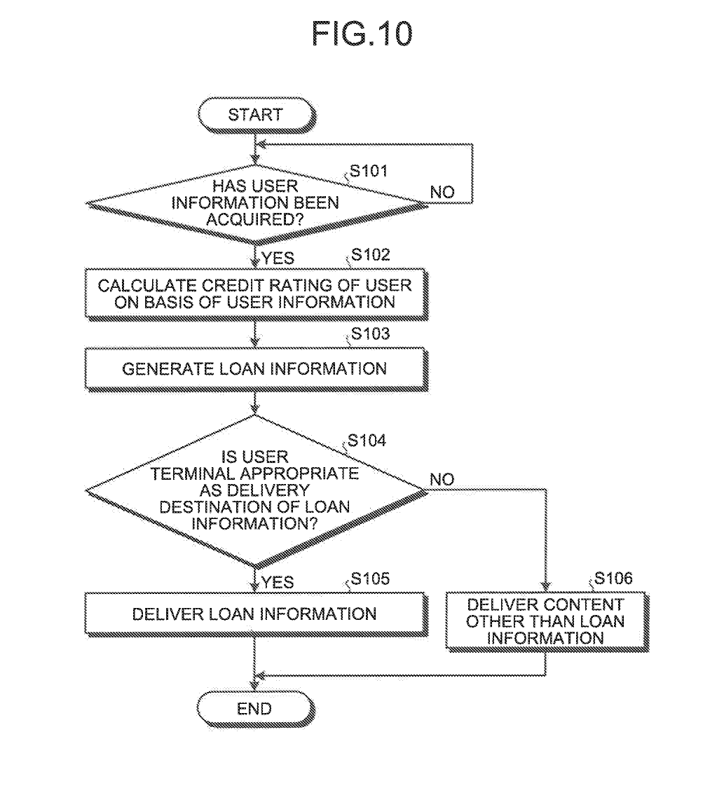

The following describes, with reference to FIG. 10, processing steps to be performed by the loan server 100 according to the embodiment. FIG. 10 is a flowchart illustrating the processing steps performed by the loan server 100 according to the embodiment.

As illustrated in FIG. 10, the acquisition unit 131 of the loan server 100 determines whether user information has been acquired (Step S101). If the acquisition unit 131 is determined yet to acquire the user information (No at Step S101), the acquisition unit 131 waits until the user information is acquired.

If the acquisition unit 131 is determined to have acquired the user information (Yes at Step S101), the calculation unit 132 calculates the credit rating of the user on the basis of the user information (Step S102).

The generation unit 133 generates loan information 50 corresponding to the user on the basis of the credit rating of the user calculated by the calculation unit 132 (Step S103). The delivery unit 134 then determines, on the basis of the loan information 50 generated by the generation unit 133 and the user information, whether the user terminal 10 corresponding to the user information is appropriate as a delivery destination of the loan information 50 (Step S104).

If the user terminal 10 is determined to be appropriate as the delivery destination of the loan information 50 (Yes at Step S104), the delivery unit 134 delivers the loan information 50 generated by the generation unit 133 to the user terminal 10 (Step S105).

If the user terminal 10 is determined not to be appropriate as the delivery destination of the loan information 50 (No at Step S104), the delivery unit 134 delivers content (e.g., advertisement content) other than the generated loan information 50 in place of the generated loan information 50 (Step S106).

6. Modifications

The delivery system 1 according to the embodiment described above may be carried out in various other modes than the above-described embodiment. The following describes the different apparatuses included in the delivery system 1 described above, according to modifications.

6-1. Displays in Various Sites

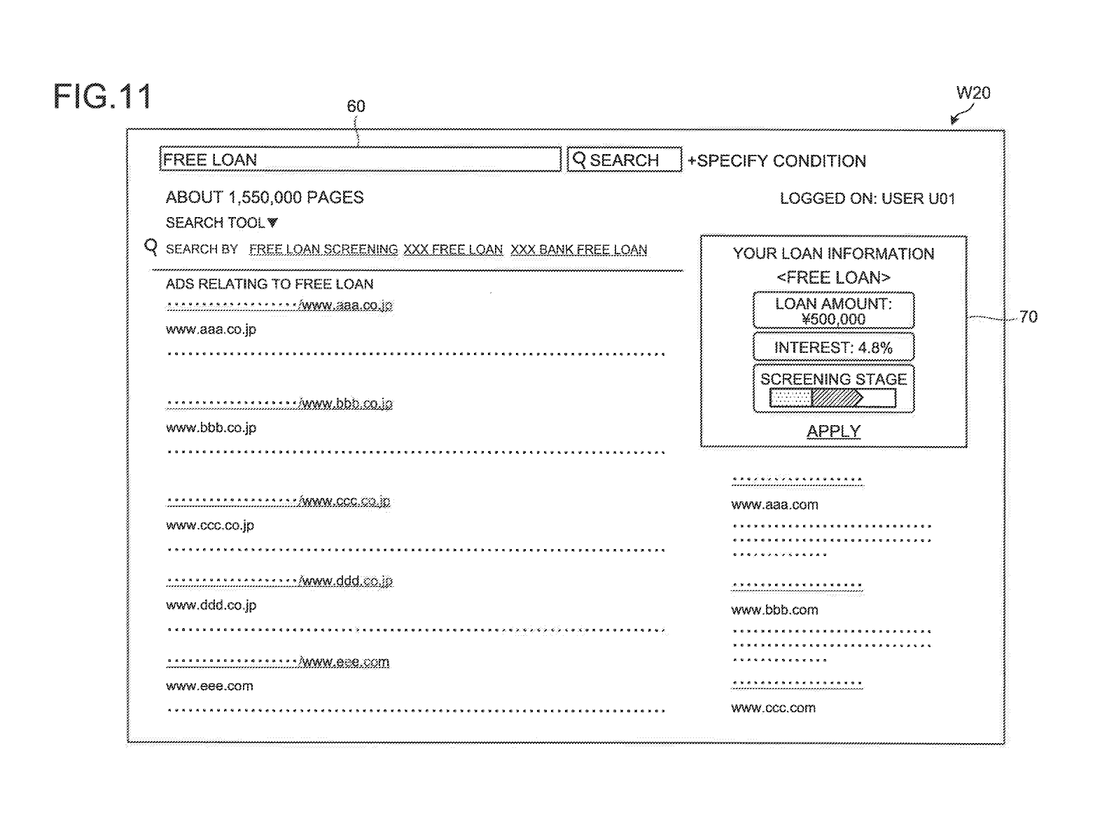

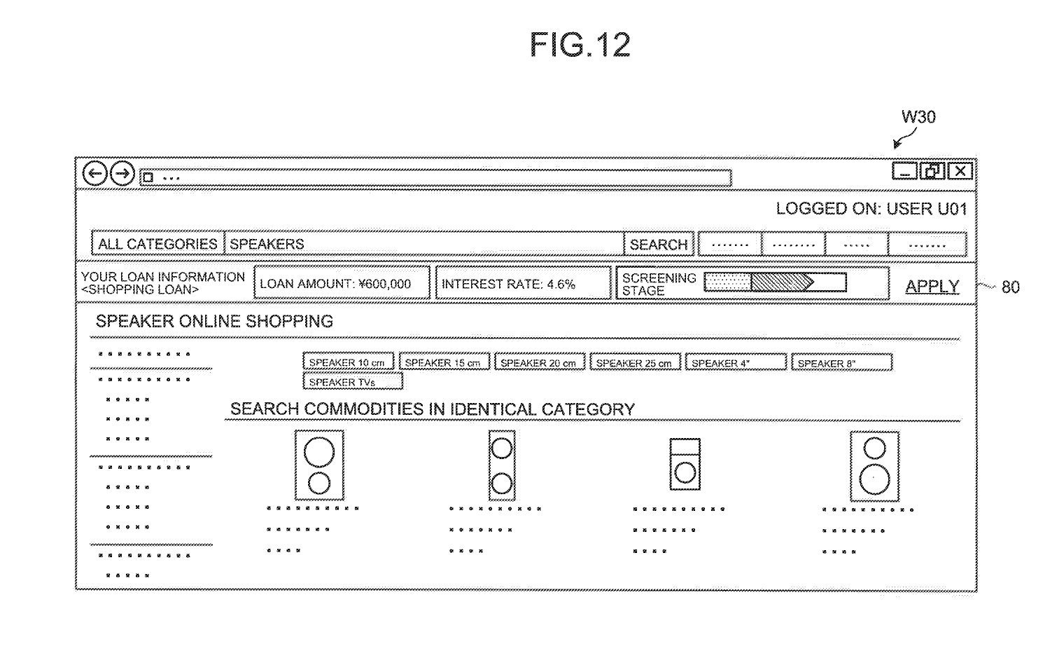

The above embodiment have been described for an exemplary case in which the loan server 100 delivers the loan information 50 to the Web page W10 associated with the portal site acquired by the user terminal 10. The loan server 100 may nonetheless deliver the loan information to a Web page of another type or category, as described above. In this case, the loan server 100 may change information to be displayed in the loan information, the type of loan indicated in the loan information, and a mode of loan information as appropriate. The following describes, with reference to FIGS. 11 and 12, the foregoing modifications.

FIG. 11 is a diagram (1) illustrating an exemplary delivery process according to a modification. FIG. 11 illustrates an example in which the loan server 100 delivers loan information 70 to a Web page W20 that is a Web page displayed by the user terminal 10 and that represents a search result page associated with a search query transmitted from the user terminal 10.

Specifically, FIG. 11 illustrates a condition in which the loan information 70 delivered from the loan server 100 is acquired in response to a request made by the user terminal 10 to acquire the Web page W20 that represents the search result page that has been obtained as a result of an input of a search query of “free loan” in a search window 60.

In this case, the loan server 100 acquires, together with user information associated with the user terminal 10, the search query transmitted from the user terminal 10 to a search service. The loan server 100 then generates the loan information 70 corresponding to the loan type related to the acquired search query. In the example of FIG. 11, the loan server 100 generates the loan information 70 including loan terms corresponding to the “free loan” as the loan type corresponding to the search query “free loan”. The loan server 100 delivers the generated loan information 70 that corresponds to the loan type related to the search query to the user terminal 10 that displays the Web page W20 as the search result page. The generated loan information 70 that corresponds to the loan type relating to the search query serves as information to be displayed together with the search result page that is delivered on the basis of the search query.

FIG. 12 is a diagram (2) illustrating an exemplary delivery process according to a modification. FIG. 12 illustrates an example in which the loan server 100 delivers loan information 80 to a Web page W30 that is a Web page displayed by the user terminal 10 and that relates to a shopping site.

Specifically, FIG. 12 illustrates a condition in which the loan information 80 delivered from the loan server 100 is acquired in response to a request made by the user terminal 10 to acquire the Web page W30 as a shopping page that has been obtained as a result of an input of a search query of “speakers” at a shopping site.

In this case, the loan server 100 acquires, as information on the Web page W30 to be displayed by the user terminal 10, information that the Web page W30 is a site at which the user buys commodities and that the Web page W30 is highly likely to serve as a venue for the user to use a loan. The loan server 100 then generates the loan information 80 that corresponds to the loan type related to the acquired Web page W30. In the example of FIG. 12, the loan server 100 generates the loan information 80 that includes the loan terms corresponding to the “shopping loan” as the loan type corresponding to the Web page W30. The loan server 100 delivers the generated loan information 80 to the user terminal 10 that displays the Web page W30.

In this case, the loan server 100 may determine whether to deliver the loan information 80 on the basis of the commodities displayed on the Web page W30. For example, the loan server 100 retains in advance information of commodities that fall into categories in which the users are highly likely to buy commodities using shopping loans, such as travel commodities, high-quality home electronics, expensive audio products, and automobiles. The loan server 100 may then deliver the loan information 80 when a Web page corresponding to a commodity that is highly likely to be purchased using a shopping loan is to be displayed.

As such, the loan server 100 can generate loan information that offers different loan terms and loan types on the basis of various types of information such as the search query, the category of the Web site relating to the Web page, and commodities displayed within the Web page. The loan server 100 can thereby deliver loan information that suits to each individual user.

6-2. Display in Portable Terminals

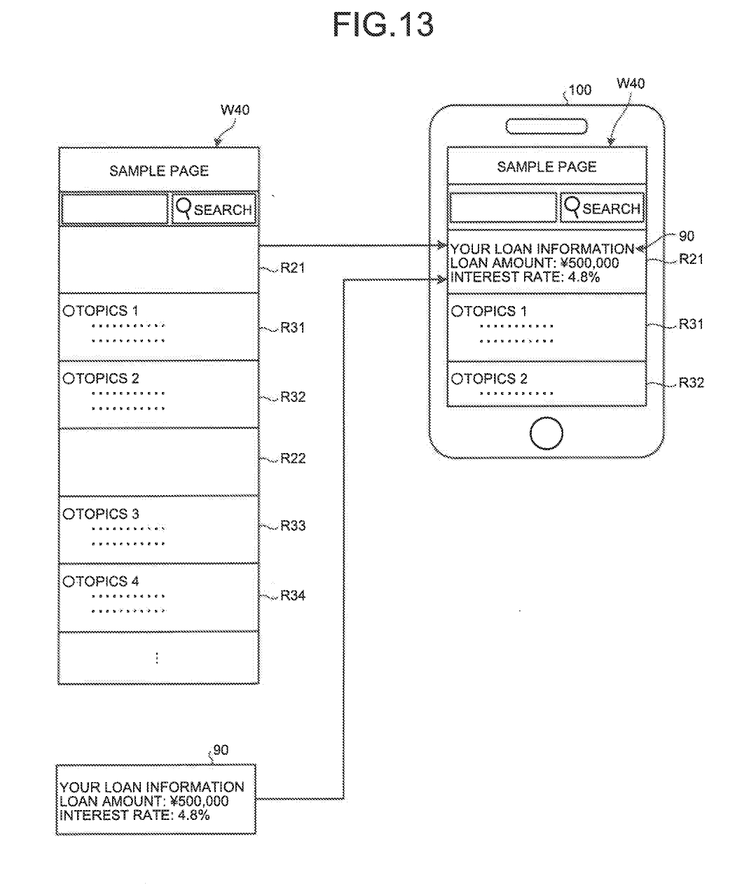

The loan server 100 may deliver the loan information to various pages, as a predetermined service page, in addition to the Web pages displayed by the Web browser on the PC. The loan server 100 may deliver the loan information to, for example, a page of an application used by a portable terminal such as a smartphone. The following describes, with reference to FIG. 13, the foregoing modification.

FIG. 13 is a diagram (3) illustrating an exemplary delivery process according to a modification. FIG. 13 illustrates the exemplary delivery process performed by the loan server 100 when the user terminal 10 is a smart device such as a smartphone.

As illustrated in FIG. 13, a sample page W40 that is displayed by an application executed by, for example, a smartphone includes areas R31, R32, R33, and R34 that display articles and areas R21 and R22 that display advertisement content items.

When the user terminal 10 is to display the sample page W40, the loan server 100 generates loan information 90 that represents loan information corresponding to the sample page W40. When the user terminal 10 is to display the sample page W40, the loan server 100 delivers the loan information 90 that serves as information to be displayed in the areas R21 and the like that differ from the areas R31 in which articles and other items are displayed.

The loan server 100 thus can deliver the loan information to not only a Web page displayed on the PC, but also a predetermined service page provided via, for example, an application. It is noted that the process performed to display the loan information 90 in the area R21 as illustrated in FIG. 13 may be performed as appropriate by the user terminal 10 that has acquired the sample page W40 and the loan information 90.

6-3. Delivery of Loan Information

The above embodiment have been described for a case in which the loan server 100 delivers the loan information by using as a trigger the acquisition of the user information transmitted by the user terminal 10 when the user terminal 10 requests a Web page. This timing at which the loan server 100 delivers the loan information is illustrative only and not limiting.

For example, the Web page delivered by the content delivery server 30 is to include a predetermined acquisition request. Such an acquisition request constitutes a request to be made to the loan server 100 to acquire loan information. The user terminal 10 that is to display the Web page that includes such an acquisition request transmits user information and the loan information acquisition request to the loan server 100 in accordance with the acquisition request.

The loan server 100 may generate and deliver the loan information in response to the acquisition request transmitted from the user terminal 10. In this case, the loan server 100 can acquire the user information without intervention of the content delivery server 30. The loan server 100 can also acquire information on the Web page to be displayed by the user terminal 10 without intervention of the content delivery server 30.

6-4. User Information

The user information acquired by the loan server 100 has been described in the above embodiment. It is noted here that the loan server 100 may also acquire information other than the user information illustrated in the above embodiment and generate the loan information on the basis of the acquired information.

For example, the loan server 100 may acquire mail transmitted by the user terminal 10 or messages contributed to Web sites and SNS services by the user terminal 10. The loan server 100 then subjects the acquired mail or the like to morphological analysis. On the basis of, for example, an occurrence rate of a word that appears in the mail or the like transmitted by the user, the loan server 100 calculates the credit rating of the user.

For example, the loan server 100 may calculate a low credit rating for a user who frequently issues a word used in debt-related situations such as “cashing”. In contrast, the loan server 100 may calculate a high credit rating for a user who frequently issues a word used in financing such as “investment”. The loan server 100 may still analyze messages issued by other users who connect to the SNS, in addition to the user for whom the credit rating is to be calculated. If a word such as “cashing” appears frequently in messages issued by other users who are connected with the user subjected to credit rating, the loan server 100 may estimate that the user subjected to credit rating has low social creditworthiness and calculate a low credit rating for the user.

Additionally, if a user frequently browses a Web page relating to particular consumer finance or loans offering high interest rates or if information is acquired indicating that a user is behind repayment schedule in another loan, for example, the loan server 100 may calculate a low credit rating for such a user.

6-5. Delivery Process

The above embodiment have been described for a case in which the loan server 100 delivers the loan information to the user terminal 10 by using as a trigger an event that displays a Web page at the user terminal 10. When the Web page side may request the user to log on as illustrated, for example, in FIG. 1, the user information is transmitted to the loan server 100 side only after the user has logged on. Upon the logon by the user, the user terminal 10 updates display of the Web page. The loan server 100 may use the timing at which the Web page is updated as a trigger to deliver the loan information. Specifically, the timing at which the loan server 100 delivers the loan information is not limited to timing at which the Web page is first displayed on the user terminal 10 and may be timing at which the Web page is updated.

6-6. Apparatuses Constituting Delivery System

Apparatuses included in the delivery system 1 may be achieved by various modifications. For example, the loan server 100 may perform processes that are to be performed by the content delivery server 30. The loan server 100 may also serve a function as an advertising server that delivers advertisement content to the Web page delivered by the content delivery server 30. In this case, the loan server 100 may select content to be delivered by, for example, delivering the loan information to users who meet the conditions for the delivery process described above and delivering advertisement content to other users.

The loan information may be displayed within a service page as one piece of user information (e.g., count of points held by the user in the shopping site) displayed in a shopping site. In this case, the loan server 100 may transmit the generated loan information to the content delivery server 30. The content delivery server 30 delivers, together with the received loan information, the service page to the user terminal 10.

For example, the delivery system 1 includes the loan server 100 and the content delivery server 30. The reception unit 34 of the content delivery server 30 receives an acquisition request for acquiring predetermined service content (e.g., Web page) from the user terminal 10 used by a user. The delivery unit 35 delivers to the loan server 100 information that includes information indicating the reception of the acquisition request. The acquisition unit 131 of the loan server 100 acquires user information that represents information on the user. The generation unit 133 generates loan information that represents information including the loan terms for the user on the basis of the user information acquired by the acquisition unit 131. The delivery unit 134 delivers to the content delivery server 30 the loan information generated by the generation unit 133 as information to be displayed together with the predetermined service content on the user terminal 10. Then, the reception unit 34 of the content delivery server 30 delivers the loan information together with the predetermined service content to the user terminal 10.

As described above, the delivery system 1 also enables delivery of the loan information to the user terminal 10 by way of the content delivery server 30. This capability allows the delivery system 1 to present the loan information that is displayed in a mode well-matched with the Web page to the user. Additionally, the delivery system 1 can display the loan information together with information on another user (e.g., count of points held by the user) to be displayed by the content delivery server 30. The loan information can thereby be presented to the user even more naturally. As such, the delivery system 1 increases the number of opportunities for the user to access loan information and to take notice of loan information, to thereby be able to promote loans over the network. It is noted that the loan server 100 may acquire user information from the content delivery server 30 or another external apparatus. The loan server 100 may even acquire the user information from the user terminal 10.

When the loan server 100 functions also to perform the processes that are to be performed by the content delivery server 30 as described above, the loan server 100 may deliver the service page together with the generated loan information to the user terminal 10. In this case, the user terminal 10 includes a transmission unit and a reception unit. Specifically, the transmission unit transmits user information and an acquisition request for acquiring a predetermined service page to the loan server 100. The reception unit receives the predetermined service page that is delivered in response to the acquisition request. The acquisition unit 131 of the loan server 100 acquires the request for acquiring the predetermined service page and the user information. The generation unit 133 generates loan information that represents information including loan terms for the user on the basis of the user information acquired by the acquisition unit 131. The delivery unit 134 delivers to the user terminal 10, together with the predetermined service page, the loan information that has been generated by the generation unit 133, as information to be displayed together with the predetermined service page on the user terminal 10. The foregoing operations enable the delivery system 1 to display on the user terminal 10 the loan information that is naturally incorporated in the service page, for example. Thus, the delivery system 1 can present the loan information quite naturally without allowing user usability to be degraded.

It is noted that a control unit (that includes the transmission unit and the reception unit described above) in the user terminal 10 is achieved by, for example, the CPU or the MPU executing various types of programs stored in a storage device inside the user terminal 10 using the RAM as a work space. Additionally, the control unit of the user terminal 10 may be achieved by an integrated circuit, such as an ASIC and an FPGA. Additionally, the user terminal 10 includes a communication unit that is achieved, for example, by a NIC.

7. Miscellaneous

Of the processes described in the above embodiment, those processes that have been described to be performed automatically may be performed manually in whole or in part, or those processes that have been described to be performed manually may be performed, in whole or in part, automatically by a well-known method. Additionally, information given in the text and drawings of the present application, including the process steps, specific names, and various types of data and parameters may be changed as necessary unless otherwise specified.

The elements of different apparatuses illustrated in the drawings are only functionally conceptual and are not necessarily required to be physically configured as illustrated. Specifically, specific configurations of distribution and integration of each apparatus are illustrative only and not limiting and the apparatuses can be functionally or physically distributed or integrated, in whole or in part, in any unit depending on, for example, load and use conditions.

For example, the user information storage unit 121 and the loan information storage unit 125 illustrated in FIG. 3 may be incorporated in, for example, an external storage server, and not in the loan server 100. In this case, the loan server 100 accesses the storage server to thereby acquire the user information, loan information, and other types of information.

Additionally, the loan server 100 may be distributed into a front-end server side and a back-end server side. Specifically, the front-end server side mainly performs operations with an external apparatus, including acquisition of user information from the content delivery server 30 and delivery of loan information to the user terminal 10. The back-end server side performs operations, including calculation of the credit ratings and generation of the loan information.

8. Hardware Configuration

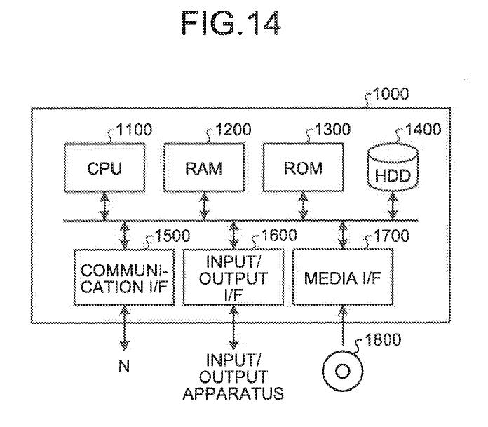

The loan server 100 according to the embodiment can be achieved by, for example, a computer 1000 having a configuration as illustrated in FIG. 14. FIG. 14 is a hardware configuration diagram illustrating an example of the computer 1000 that achieves the functions of the loan server 100. The computer 1000 includes a CPU 1100, a RAM 1200, a ROM 1300, a HDD 1400, a communication interface (I/F) 1500, an input/output interface (I/F) 1600, and a media interface (I/F) 1700.

The CPU 1100 operates in accordance with a program stored in the ROM 1300 or the HDD 1400 to thereby control the different elements. The ROM 1300 stores, for example, a boot program executed by the CPU 1100 during starting of the computer 1000 and a program dependent on hardware of the computer 1000.

The HDD 1400 stores, for example, a program executed by the CPU 1100 and data used by such a program. The communication I/F 1500 receives data from another apparatus and transmits the data to the CPU 1100 via a communication network 500. The communication I/F 1500 further transmits data generated by the CPU 1100 to the other apparatus via the communication network 500 (that corresponds to the network N illustrated in FIG. 2).

The CPU 1100 controls an output device such as a display and a printer and an input device such as a keyboard and a mouse via the input/output I/F 1600. The CPU 1100 acquires data from the input device via the input/output I/F 1600. Additionally, the CPU 1100 outputs the generated data to the output device via the input/output I/F 1600.

The media I/F 1700 reads a program or data stored in a recording medium 1800 and provides the CPU 1100 with the program or data via the RAM 1200. The CPU 1100 loads the program from the recording medium 1800 via the media I/F 1700 in the RAM 1200 and executes the loaded program. The recording medium 1800 may, for example, be an optical recording medium such as a digital versatile disc (DVD) and a phase change rewritable disk (PD), a magneto-optical recording medium such as a magneto-optical disk (MO), a tape medium, a magnetic recording medium, or a semiconductor memory.

When the computer 1000 functions as the loan server 100, for example, the CPU 1100 of the computer 1000 executes a program loaded on the RAM 1200 to achieve the functions of the control unit 130. Additionally, the HDD 1400 stores therein data of the storage unit 120. The CPU 1100 of the computer 1000, while loading the program from the recording medium 1800 and executing the program, may alternatively acquire the program from another apparatus via the communication network 500.

9. Advantageous Effects

As described above, the loan server 100 according to the embodiment includes the acquisition unit 131, the generation unit 133, and the delivery unit 134. The acquisition unit 131 acquires user information that represents information relating to a user. The generation unit 133 generates loan information that represents information including loan terms for the user on the basis of the user information acquired by the acquisition unit 131. The delivery unit 134 delivers the loan information generated by the generation unit 133 to the user terminal 10 by using as a trigger display of a predetermined service page (exemplary service content) in the user terminal 10 used by the user.

The loan server 100 according to the embodiment can thus deliver the loan information as information to be presented to the user when the service page is displayed. Thereby, the loan server 100 can cause the user to automatically acquire the loan terms for which the user can apply through daily behavior of visiting the service page. For example, the loan server 100 can cause the user to acquire the loan terms by displaying the loan information in place of advertisement content that is typically displayed together with a Web page. To state differently, the loan server 100 can give the user U01 a chance to use a loan without causing the user U01 to take the trouble of visiting a page provided by a financial institution or inputting information about himself or herself. As a result, the loan server 100, because being able to present loan terms to those users who are not particularly interested in loans and those who are being hesitant to confirm whether a loan can be used, can promote loans over the network.

The acquisition unit 131 acquires information relating a predetermined service page. The generation unit 133 generates loan information that corresponds to the loan type related to the predetermined service page acquired by the acquisition unit 131. As information displayed together with the predetermined service page, the delivery unit 134 delivers to the user terminal 10 that displays the predetermined service page the loan information that has been generated by the generation unit 133 and that corresponds to the type related to the information on the predetermined service page.

As described above, the loan server 100 according to the embodiment can display the loan information of the loan type corresponding to the service page which the user terminal 10 is to display. The loan server 100 thus can deliver the loan information that is tailored to interest of the user, to thereby be able to promote applications for the loan.

The loan server 100 according to the embodiment further includes the calculation unit 132 that calculates the credit rating of the user on the basis of the user information acquired by the acquisition unit 131. The generation unit 133 generates the loan information for the user on the basis of the credit rating of the user calculated by the calculation unit 132.

As described above, the loan server 100 according to the embodiment calculates the credit rating on the basis of the user information and delivers the loan information based on the calculated credit rating to the user. The loan server 100 thus can propose an appropriate loan in accordance with the credit rating.

Additionally, the acquisition unit 131 acquires position information of the user. The calculation unit 132 estimates whether the user has a steady job on the basis of a plurality of pieces of position information that are acquired on a daily basis and that indicate a predetermined range out of pieces of position information acquired by the acquisition unit 131, to thereby calculate the credit rating of the user.

As described above, the loan server 100 according to the embodiment can calculate the credit rating of the user on the basis of the position information of the user. Specifically, the loan server 100 estimates whether the user has a steady job using the position information of the user. The loan server 100 calculates the credit rating of the user on the basis of the estimated information. These arrangements enable the loan server 100 to accurately calculate the credit rating of the user even without having, for example, a notification from the user.

The acquisition unit 131 acquires, as user information, a behavior history of the user on the network. The calculation unit 132 calculates the credit rating of the user on the basis of the behavior history of the user on the network acquired by the acquisition unit 131.

As described above, the loan server 100 according to the embodiment calculates the credit rating on the basis of the behavior history on the network to thereby be able to present loan terms in accordance with a specific situation of the user and daily behavior of the user.

Additionally, the acquisition unit 131 acquires a history of the user in terms of buying behaviors of the user on the network. The calculation unit 132 calculates the credit rating of the user on the basis of at least any one of the purchase amounts in the buying behavior, frequency of the buying behavior, and evaluation of the user at a service the user visits in the buying behavior, acquired by the acquisition unit 131.

As described above, the loan server 100 according to the embodiment calculates the credit rating on the basis of information relating to buying activities of the user tending to directly lead to the loan. The loan server 100 can thereby generate loan information that presents loan terms suitable for the user.

The acquisition unit 131 acquires information on at least any one of the name recognition, reputation, and personal connections of the user within a service for building a social network used by the user. The calculation unit 132 calculates the credit rating of the user on the basis of the information, acquired by the acquisition unit 131, on at least any one of the name recognition, reputation, and personal connections of the user within the service for building a social network.

As described above, the loan server 100 according to the embodiment may calculate the credit rating using information of the social network such as the SNS. The loan server 100 thus can calculate the credit rating of the user, including not only the behavior of a specific user, but also behaviors of other users with whom the specific user keeps company, to thereby be able to calculate the credit rating with high accuracy.

The acquisition unit 131 acquires a browsing history that represents a history of browsing, by the user, services provided on the network. The calculation unit 132 calculates the credit rating of the user on the basis of the browsing history acquired by the acquisition unit 131.

As described above, the loan server 100 according to the embodiment refers to the browsing history of the user on the network. The loan server 100 thus identifies specific interest the user has, to thereby be able to adequately adjust the loan information, including selecting an appropriate loan type and calculating a low credit rating for a user who frequently visits a Web page that is undesirable as a lender.

The acquisition unit 131 acquires a search query that is transmitted from the user terminal 10 to a predetermined search service. The generation unit 133 generates loan information corresponding to the loan type related to the search query acquired by the acquisition unit 131. The delivery unit 134 delivers to the user terminal 10 that displays a search result page, loan information that is generated by the generation unit 133 and that corresponds to the loan type related to the search query. The loan information is delivered as information to be displayed together with the search result page delivered on the basis of the search query.

As described above, the loan server 100 according to the embodiment may generate the loan information by selecting the loan type on the basis of the search query transmitted by the user. The loan server 100 thus can display, together with the search result page, the loan information that is tailored to interest of the user. The loan server 100 can thereby achieve a greater appealing effect of the loan information to be delivered.

The acquisition unit 131 acquires information relating to a service having a high loan usage rate at which a certain user uses a loan. The delivery unit 134 delivers, as information to be displayed together with the page relating to the service that has a high loan usage rate at which a certain user uses a loan, the loan information to the user terminal 10.

As described above, the loan server 100 according to the embodiment may perform a process to determine a user to whom the loan information is to be delivered (specifically, the page on which the loan information is to be displayed) according to the loan usage rate in the service page. The loan server 100 thus can increase a probability of the loan presented in the loan information to be used.

The delivery unit 134 delivers to the user terminal 10 the loan information generated by the generation unit 133 as information that is to be displayed together with any one of the following pages: a portal site page on which information is built for each visiting user, a search result page as a result of using a search service, and an E-commerce page on which a commodity can be purchased.

As described above, the loan server 100 according to the embodiment displays the loan information on, for example, a portal site page that is visited frequently by the user, a search result page that allows user's interest to be identified, and an E-commerce (e.g., shopping) page on which the user tends to use a loan. The loan server 100 thus can increase a probability of the loan presented in the loan information to be used.

The delivery unit 134 delivers the loan information to the user terminal 10 that is used by a user who has ever applied for a predetermined loan and failed in screening of the application.

As such, the loan server 100 according to the embodiment may select the delivery destination of the loan information on the basis of a past loan history. This arrangement enables the loan server 100 to deliver the loan information to a user who is motivated to use a loan, so that a conversion rate of the loan information to be delivered can be improved.

The delivery unit 134 delivers loan information to the user terminal 10 that is used by a user who is qualified for receiving the loan indicated in the loan information at a time when the loan information is generated by the generation unit 133.

As described above, the loan server 100 according to the embodiment determines qualification for receiving the loan on the basis of the user information. As a result, the loan server 100 can avoid generating wasteful impressions of the loan information.

Additionally, the delivery unit 134 delivers the loan information to the user terminal 10 that is used by a user who is still entitled to the loan with respect to the loan amount indicated in the loan information.

As described above, the loan server 100 according to the embodiment determines the delivery destination on the basis of information on the loan amount to which the user is currently entitled. As a result, the loan server 100 can avoid generating wasteful impressions of the loan information.

Embodiments of the present application have been described in detail with reference to the accompanying drawings. The embodiments are, however, illustrative only and are not limiting. In addition to the modes described in the disclosure of the invention, the invention can be carried out in various other forms that represent various modifications and improvements made to the invention on the basis of knowledge of persons skilled in the art.

The configuration of the above-described loan server 100 may be flexibly modified, including achieving the loan server 100 by a plurality of server computers and, depending on the function, achieving the loan server 100 by calling an external platform, for example, using an application programming interface (API) or network computing.

It is further noted that the “unit” and “units” stated in the claims can be read as “means” or “circuits” as appropriate. For example, the acquisition unit may be read as acquisition means or an acquisition circuit.

One embodiment can provide the effect of promoting the loan over the network.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A delivery apparatus comprising:
an acquisition unit that acquires user information that represents information relating to a user;
a generation unit that generates, using the user information acquired by the acquisition unit, loan information that represents information including loan terms for the user; and
a delivery unit that delivers the loan information generated by the generation unit to a terminal apparatus that is used by the user by using, as a trigger, display of predetermined service content at the terminal apparatus.

2. The delivery apparatus according to claim 1, wherein
the acquisition unit acquires information relating to the predetermined service content,
the generation unit generates loan information that corresponds to a loan type related to the predetermined service content acquired by the acquisition unit, and
the delivery unit delivers to the terminal apparatus that displays the predetermined service content, loan information that is generated by the generation unit and that corresponds to a type related to information on the predetermined service content, as information to be displayed together with the predetermined service content.

3. The delivery apparatus according to claim 1, further comprising:
a calculation unit that calculates a credit rating of the user using the user information acquired by the acquisition unit, wherein
the generation unit generates loan information for the user using the credit rating of the user calculated by the calculation unit.

4. The delivery apparatus according to claim 3, wherein
the acquisition unit acquires position information of the user, and
the calculation unit estimates whether the user has a steady job using, out of the position information acquired by the acquisition unit, a plurality of pieces of position information that are acquired on a daily basis and that indicate a predetermined range, to calculate the credit rating of the user.

5. The delivery apparatus according to claim 3, wherein
the acquisition unit acquires a behavior history of the user on a network as the user information, and
the calculation unit calculates the credit rating of the user using the behavior history of the user on the network acquired by the acquisition unit.

6. The delivery apparatus according to claim 5, wherein
the acquisition unit acquires a history on buying behavior of the user on the network, and
the calculation unit calculates the credit rating of the user using at least either one of a purchase amount in the buying behavior, frequency of the buying behavior, and evaluation of the user at a service the user visits in the buying behavior, acquired by the acquisition unit.

7. The delivery apparatus according to claim 5, wherein
the acquisition unit acquires information on at least either one of name recognition, reputation, and personal connections of the user within a service for building a social network used by the user, and
the calculation unit calculates the credit rating of the user using the information, acquired by the acquisition unit, on at least either one of the name recognition, reputation, and personal connections of the user within the service for building a social network used by the user.

8. The delivery apparatus according to claim 5, wherein
the acquisition unit acquires a browsing history that represents a history of browsing, by the user, service content provided on the network, and
the calculation unit calculates the credit rating of the user using the browsing history acquired by the acquisition unit.

9. The delivery apparatus according to claim 1, wherein
the acquisition unit acquires a search query transmitted from the terminal apparatus to a predetermined search service,
the generation unit generates loan information that corresponds to the loan type related to the search query acquired by the acquisition unit, and
the delivery unit delivers to the terminal apparatus that displays a search result page, loan information that is generated by the generation unit and that corresponds to the loan type related to the search query, the loan information being delivered as information to be displayed together with the search result page delivered based on the search query.

10. The delivery apparatus according to claim 1, wherein
the acquisition unit acquires information on a service having a high loan usage rate at which a certain user uses a loan, and
the delivery unit delivers the loan information to the terminal apparatus as information to be displayed together with content related to the service having a high loan usage rate at which the certain user uses a loan.

11. The delivery apparatus according to claim 1, wherein
the delivery unit delivers to the terminal apparatus, the loan information generated by the generation unit as information to be displayed together with any one of a portal site page on which information is built for each visiting user, a search result page as a result of using a search service, and an E-commerce page on which a commodity is available for purchase.

12. The delivery apparatus according to claim 1, wherein
the delivery unit delivers the loan information to the terminal apparatus that is used by a user who has ever applied for a predetermined loan and failed in screening of the application for the predetermined loan.

13. The delivery apparatus according to claim 1, wherein
the delivery unit delivers the loan information to the terminal apparatus that is used by a user who is qualified for receiving a loan indicated in the loan information at a time when the loan information is generated by the generation unit.

14. The delivery apparatus according to claim 1, wherein
the delivery unit delivers the loan information to the terminal apparatus that is used by a user who is still entitled to a loan with respect to a loan amount indicated in the loan information at a time when the loan information is generated by the generation unit.

15. A delivery method that is executed by a computer, the delivery method comprising:
acquiring user information that represents information relating to a user;
generating, using the user information acquired at the acquiring, loan information that represents information including loan terms for the user; and
delivering the loan information generated at the generating to a terminal apparatus that is used by the user by using, as a trigger, display of predetermined service content at the terminal apparatus.

16. A non-transitory computer readable storage medium having stored therein a delivery program causing a computer to execute a process comprising:
acquiring user information that represents information relating to a user;
generating, using the user information acquired at the acquiring, loan information that represents information including loan terms for the user; and
delivering the loan information generated at the generating to a terminal apparatus that is used by the user by using, as a trigger, display of predetermined service content at the terminal apparatus.

17. A delivery system comprising:
a delivery apparatus; and
a content delivery server, the content delivery server including:
a reception unit that receives from a terminal apparatus used by a user, an acquisition request for acquiring predetermined service content; and
a delivery unit that delivers information that includes information indicating the reception of the acquisition request to the delivery apparatus, and
the delivery apparatus including:
an acquisition unit that acquires user information that represents information relating to the user;
a generation unit that generates, using the user information acquired by the acquisition unit, loan information that represents information including loan terms for the user; and
a delivery unit that delivers the loan information generated by the generation unit to the content delivery server as information to be displayed together with the predetermined service content at the terminal apparatus, wherein
the delivery unit of the content delivery server delivers to the terminal apparatus, the loan information together with the predetermined service content.
